(19) United States
(12) Patent Application Publication
(10) Pub. No.: US 2015/0064329 A1
(43) Pub. Date: Mar. 5, 2015

(54) BAKERY FAT SYSTEM

(71) Applicant: CARGILL, INCORPORATED, Wayzata, MN (US)

(72) Inventors: Serpil Metin, Eden Prairie, MN (US); Paul Raymond Smith, Waterloo (BE); Sarah Veelaert, Eppegem (BE); Patrick Moran, Little Canada, MN (US); Daniele Marie-Antoinette Karleskind, Wezembeek-Oppem (BE)

(73) Assignee: CARGILL, INCORPORATED, Wayzata, MN (US)

(21) Appl. No.: 14/390,232

(22) PCT Filed: Apr. 1, 2013
(86) PCT No.: PCT/US13/34804

§ 371 Date: Oct. 2, 2014

Related U.S. Application Data
(60) Provisional application No. 61/619,099, filed on Apr. 2, 2012.

(30) Foreign Application Priority Data
Jun. 4, 2012 (EP) 12004242.9

(51) Int. Cl. A21D 10/00

(52) U.S. Cl. CPC A21D 10/005
USPC 426/556

(57) ABSTRACT

The invention relates to a bakery fat system that is low in trans- and saturated fatty acids. A process for making the system of the present invention is also disclosed and a use in bakery applications, in particular in pastry applications, is also disclosed. In a first aspect, the present invention relates to a bakery fat system comprising from 30 weight/weight % (w/w %) to 75 w/w %, of a lipid and from 25 w/w % t 70 w/w % of a porous edible particle, characterized in that said bakery fat system is a structured fat system wherein the lipid is present as a continuous phase. In a second aspect, the present invention relates to a process for making the bakery fat system, a bakery product comprising the bakery fat system and further bakery ingredients, and the use of the bakery fat system in bakery applications, in particular in pastry applications, are also disclosed.

### CROSS REFERENCE TO RELATED APPLICATION

This application claims the benefit of the U.S. Provisional Patent Application, Ser. No. 61/61,099, filed Apr. 2, 2012, BAKERY FAT SYSTEM, and to European Provisional Patent Application, Serial No. 12004242.9, BAKERY FAT SYSTEM, filed Jun. 4, 2012, which is hereby incorporated by reference in its entirety.

### FIELD OF THE INVENTION

The invention relates to a bakery fat system that is low in trans- and saturated fatty acids. A process for making the system of the present invention is also disclosed and a use in bakery applications, in particular in pastry applications, is also disclosed.

### BACKGROUND OF THE INVENTION

Solid fat systems are useful in many food applications in order to provide structure and stability. Solid fat systems contain lipid in solid form, in order to have the required functionality.

Nowadays, many oils are made solid through hydrogenation. Hydrogenation is a process commonly used to treat vegetable oils in order to increase their functionality by making them harder and of a comparable texture to butter for example. This process increases the saturated fatty acid content of the oil. Saturated fatty acids are fatty acids which do not contain any double bonds between the carbon atoms of the fatty acid chain. During the hydrogenation process, trans fatty acids are also formed. Trans fatty acids are unsaturated fatty acids in which the hydrogen atoms of a double-bond, are located on opposite sides of the molecule. Generally they are only found in low amounts in naturally occurring oils and fats. A trans fat is an unsaturated fat with trans-isomer fatty acids.

Traditionally, the food industry is using solid fat systems based on animal fats (like butter or lard) which are rich in saturated fatty acids, harder vegetable oils (like palm oil) which are rich in saturated fatty acids and hydrogenated vegetable oils (from soybean or sunflower oil for example) which can be rich in trans fatty acids and saturated fatty acids. These hydrogenated oils have been subject to intensive research and studies have shown that the excessive consumption of these types of fats is one of the main causes of modern diseases such as cardiovascular diseases, obesity and some types of cancer. Industry is put more and more under pressure to reduce the amount of unhealthy fats in all kind of food applications. With this problem in mind, a lot of systems have been developed to replace trans fat and/or saturated fat in food applications; some of them being entirely free of fat. Most of them have

a paste-like structure that mimics the structure of fat. However, for some sensitive food applications, such as bakery and in particular pastry, these fat replacers cannot be used. In general, these fat replacers are indicated in the replacement of fat for a very limited range of food applications.

Fat replacement is a difficult issue because fat plays a very important role in the manufacture and in the organoleptic properties of food. It also imparts the final aspect of many food applications, in particular bakery applications and even more particularly pastry applications. In the latter, fat is a plasticizer, it confers the right viscosity to the dough and it is needed for the creation of multiple layers in pastry and puff pastry products. Fat is thus partly responsible for the typical layered appearance of pastry products. In the finished product, fat is a tenderizer, it plays a role in the retention of freshness.

U.S. Pat. No. 8,029,847 B2 provides a trans fat replacement system.

One of the properties of oils is that they are free of trans fatty acids and free of saturated fatty acids. Unfortunately, oils do not have the necessary structure for imparting a specific texture to food applications, in particular bakery applications. Oils cannot be used to create the dough structures that are necessary for baked goods. In particular, they cannot be used to create the structures needed for pastry and more particularly for puff pastry products.

There is thus a need for providing a saturated and trans fat replacement system based on oil, that can be used in bakery applications but more importantly in pastry applications, and that fully replicate the properties of the traditional fat or fat system.

### SUMMARY OF THE INVENTION

In a first aspect, the present invention relates to a bakery fat system comprising from 30 weight/weight % (w/w %) to 75 w/w %, of a lipid and from 25 w/w % to 70 w/w % of a porous edible particle, characterized in that said bakery fat system is a structured fat system wherein the lipid is present as a continuous phase.

In a second aspect, the present invention relates to a process for making the bakery fat system of the present invention.

In a third aspect, the present invention relates to a bakery product comprising the bakery fat system of the present invention and further bakery ingredients.

In a fourth aspect, the present invention relates to use of the bakery fat system of the present invention in bakery applications.

### DETAILED DESCRIPTION

In a first aspect, the present invention relates to a bakery fat system comprising from 30 w/w % to 75 w/w % of a lipid and from 25 w/w % to 70 w/w % of a porous edible particle, characterized in that that said bakery fat system is a structured fat system wherein the lipid is present as a continuous phase.

The bakery fat system comprises preferably from 30 to 70 w/w %, more preferably from 30 to 60 w/w %, even more preferably from 32 to 60 w/w % of a lipid.

The bakery fat system comprises preferably from 30 to 70 w/w %, more preferably from 40 to 70 w/w %, even more preferably from 40 to 68 w/w % of a porous edible particle.

Bakery Fat System

A bakery fat system is a fat system which is suitable for making bakery products. The term ‘system’ is used in the present invention to emphasize that the bakery fat is composed of several ingredients, chemically and biologically not necessarily related to one another, which must be present in certain ratios and which must interact in a certain particular way.

Bakery products can be low fat products or high fat products. The present invention is particularly concerned with high fat bakery products. However, the fat system of the present invention can also be used in low fat bakery products. Low fat bakery products are for example breads, low fat sponge cakes, low fat cookies. High fat bakery products contain in general more than 20% by weight of fresh dough of fat (i.e. in this respect fat or fat system). Such products are for example cakes, high fat sponge cakes, muffins, pastries and puff pastries.

In a preferred embodiment of the present invention, the bakery fat system is a pastry fat system, i.e. suitable for making pastry products. It is suitable for making pastry products because it is a plastic mass capable of being layered and laminated between layers of dough without leaking into the dough and without leaking out of the dough layers. Pastry is the name for bakery goods made from flour, water and 20w/w % of fat or more. Optionally, pastry may also comprise sugar, salt, eggs and other ingredients. Short crust pastry, also known as pie crust pastry is the simplest form of pastry. Typically all ingredients are blended to form a dough and the dough is rolled out and baked.

Some pastry products, known as puff pastry, are a special type of pastry products and are characterized by their typical layered aspect. This layered aspect is very important for the quality perception of such products. They must be crispy and light, i.e. the layers must be spaced and not compact. Fat is partly responsible for this layered aspect. Production of puff pastry products is made by laminating layers of dough over layers of fat, sometimes more than 100 alternating layers of dough and fat are produced. The doughs coming out of such process are typically called roll-in doughs or rolled-in doughs. And fat suitable for producing such doughs are typically called roll-in fat. Different kinds of puff pastry exist. Some require alternate layers of fat and doughs. For other puff pastry products a smooth and continuous layer of fat between dough layers is not particularly desirable. The roll-in process is adjusted somewhat to achieve numerous discrete particles of fat between the dough layers. These produce somewhat larger voids in the finished product.

Thus in a more preferred embodiment of the present invention, the bakery fat system is a puff pastry fat system, i.e. suitable for making puff pastry products.

One fat commonly used as pastry fat, more particularly as puff pastry fat, is clarified butter, which is capable of being layered and laminated. Other suitable fats are lard and Crisco®. Not all bakery fat systems are capable of being layered and laminated. This is why pastry fat and more particularly puff pastry fat can be seen as a special type of bakery fat. To achieve this purpose, the inventors have surprisingly found that certain combinations of porous edible particles and lipid are able to be laminated and layered and are thus suitable for making pastry products, more particularly puff pastry products. In a preferred embodiment, combinations of porous edible particles and oil and fat in certain ratios are found to be particularly suitable to be laminated and layered and are thus suitable for making pastry products, more particularly puff pastry products. Since all bakery products can be made with fat or fat systems suitable for pastry products, the fat system of the present invention also is suitable for making bakery products.

The bakery fat system of the present invention preferably has a hardness of from 0.5 to 2.5 kg. Preferably, the hardness is from 1 to 2 kg and more preferably from 1.4 to 1.8 kg.

The bakery fat system of the present invention can also be characterized by its maximum elastic and loss modulus. The maximum elastic modulus is preferably from 150000 Pa to 3000000 Pa and more preferably from 1500000 to 3000000 Pa and even more preferably from 2000000 Pa to 3000000 Pa. The maximum loss modulus is preferably form 40000 Pa to 400000 Pa and more preferably form 200000 Pa to 300000 Pa.

The bakery fat system of the present invention can also be characterized by its elastic and loss modulus at its melting point. The elastic modulus is preferably from 200 Pa to 1500 Pa and more preferably from 600 Pa to 1200 Pa. The loss modulus is preferably form 200 Pa to 1500 Pa and more preferably form 600 Pa to 1200 Pa.

Lipid

The lipid can be any lipid, such as oil, fat, wax and the like. Preferably, the lipid comprises oil and fat. More preferably, the lipid consists of oil and fat. Oil is a triglyceride in liquid form at room temperature while fat is a triglyceride in solid or semi-solid form of at room temperature. Room temperature is from around 20° C. to around 25° C.

The oil can be any edible oil, such as sunflower oil, high oleic sunflower oil, corn germ oil, wheat kernel oil, rapeseed oil, safflower oil, flaxseed oil, soybean oil, palm kernel oil, palm olein, canola oil, cottonseed oil, fish oil and mixtures of two or more thereof. Preferably, the oil is sunflower oil.

The fat can be any edible fat, such as lard, tallow, butter oil, cocoa butter, palm stearin, coconut oil, fully hydrogenated vegetable oil, hydrogenated fish oil and mixtures of two or more thereof. Preferably the fat is saturated fat. Preferably, the fat is palm stearin.

In the bakery fat system of the present invention, the interaction between the lipid and the porous edible particle must be such that in the final bakery fat system, the lipid forms a continuous, i.e. substantially non interrupted phase, wherein the porous edible particles are distributed. The porous edible particles act as a network builder structuring the lipid phase and providing a structured fat system. Thus the fat system is structured by the presence and configuration of the porous edible particles acting as and replacing fat crystals.

In a preferred embodiment, the ratio of edible porous particle, oil and fat is from 1:1:1 to 1:2:3.

Porous Edible Particle

The porous edible particle can be any suitable porous edible particle such as for example a starch particle such as for example a starch granule; a protein particle; a fibre particle; a hydrocolloid particle; cocoa powder; or combinations thereof. A particle for the purpose of the present invention can also be an aggregate of smaller particles.

Typically, the porous particle for the purpose of the present invention has an oil absorption capacity of from 10 to 50%, preferably form 15 to 50%, more preferably from 15 to 40%, even more preferably from 15 to 35% and yet even more preferably form 20 to 25%.

Further, the porous edible particle for the purpose of the present invention typically has a diameter or an equivalent diameter of 1 to 500 μm, preferably of 50 to 200 μm and more preferably from 100 to 150 μm. The equivalent diameter is used for non spherical particles and is numerically equal to the diameter of a spherical particle having the same density as the particle under test. The porous particle can also be characterized by its particle size distribution. Further, a porous particle for the purpose of the present invention typically has a specific surface area of from 0.2 to 2 m²/g, preferably from 0.2 to 1.5 m²/g, even more preferably from 0.2 to 1.2 m²/g. In a most preferred embodiment, the porous particle of the present invention has a specific surface of from 0.5 to 1.2 m²/g.

Further, the porous particle for the purpose for the present invention has a density of from 0.2 to 0.8 g/cm³, preferably of from 0.2 to 0.6 g/cm³, more preferably of from 0.2 to 0.5 g/cm³, even more preferably of from 0.3 to 0.5 g/cm³.

Further, the pore size of the porous particle is typically from 1 to 100 μm, preferably from 1 to 20 μm. The pore size can for example be measured with a suitable microscope.

Thus a porous edible particle is an edible particle having pores wherein the pores can be in the form of holes present on the surface of the particle or in the form of interconnected cavities through the particle.

Oil absorption capacity, diameter, specific surface and density are measured according to the methods described in a further part of this description.

Such porous edible particle can be obtained by any method suitable to modify an edible particle so as to create pores, holes or openings in the structural lattice of the edible particle. The porosity can be more or less extensive. The porosity is less extensive when the pores, holes or openings are merely superficially present in the particle. The porosity is extensive when the pores, hales or openings are in the form of interconnecting cavities through the particle. Any porosity between these two extremes can be obtained by adjusting the production method. Such methods are for example freeze drying, spray drying, roll drying, extrusion and partial enzymatic degradation. In one embodiment, porous edible particles can be obtained by spray drying different types of particles, for example different types of starch granules, with small amounts of bonding agents such as proteins, gelatine, carboxymethylcellulose, guar gum, locust bean gum, starch dextrin, pectin, alginate.

In a highly preferred embodiment, the porous edible particle is a porous starch granule. Starch granules are present in most plant cells and consist of highly ordered crystalline regions and less organized amorphous regions. When present in this granular state, the starch is referred to as ‘native starch’.

Suitable sources of starch granules for use in the present invention are corn, pea, potato, sweet potato, sorghum, banana, barley, wheat, rice, sago, amaranth, tapioca, arrowroot, canna, and low amylose (containing no more that about 10% by weight amylose, preferably no more than 5% by weight amylose) or high amylose (containing at least about 40% by weight amylose) varieties thereof. Genetically modified varieties of these crops are also suitable sources of starch granules. A preferred starch granule for use herein is starch with an amylose content below 40% by weight, including waxy corn starch with less than 1% by weight amylose content. Particularly preferred sources include corn, and potato. It is well known in the art how to extract the starch granules from these plants.

The starch of the starch particle may be chemically modified, enzymatically modified, modified by heat treatment or by physical treatment. The term “chemically modified” or “chemical modification” includes, but is not limited to crosslinking, modification with blocking groups to inhibit retrogradation, modification by the addition of lipophilic groups, acetylated starches, hydroxyethylated and hydroxypropylated starches, inorganically esterified starches, cationic, anionic and oxidized starches, zwitterionic starches, starches modified by enzymes and combinations thereof. It is important however for the present invention that these processes do not disrupt the granular structure of the starch. Heat treatment includes for example pregelatinization. Thus the starch particle can comprise starch in the granular state or in the non-granular state, i.e. the granular state of the starch has been disrupted by physical, thermal, chemical or enzymatic treatment.

Porous starch particle can be a porous starch granule. Porous starch granules can be obtained as follows. The starch granules have been modified by processing, preferably by enzyme treatment, resulting in the granule having holes, pores or openings which allow smaller molecules to enter the interstices of the starch granules. The starch granules suitable for modification and for use in the present invention may comprise any starch which is capable of being modified to increase pore volume or surface area, for example, corn or potato starch. An example of porous starch granules suitable for use in the present invention are starch granules modified by treatment, usually by amylolytic enzymes, to increase the pore volume and thereby producing a microporous starch matrix. Any of a wide variety of art-recognized alpha-amylase or glucoamylases including those derived from Rhizopus niveus, Aspergillus niger, and Rhizopus oryzae and Bacillus subtilis and alpha-amylases and glucoamylases of animal origin, can be used. Micorporous starch granules prepared by the action of acid or amylase on granular starch are well known in the literature, see for example, Starch Chemistry and Technology, Whistler, Roy L., 2^{nd} Edition (1984), Academic Press, Inc. New York, N.Y. These methods and others, as well as those disclosed herein, are suitable for preparing a porous starch matrix. The duration of enzyme treatment necessary to produce microporous starch matrices suitable for use in the present invention depends on a number of variables, including the source of starch, species and concentration of amylases, treatment temperature, and pH of the starch slurry. The progress of starch hydrolysis can be followed by monitoring the D-glucose content of the reaction slurry.

The porous starch particle can be a porous particle comprising non granular starch.

Method of Making the Bakery Fat System

A second aspect of the present invention relates to a process for making the bakery fat system of the present invention, comprising the steps of:
a. Mixing a liquid lipid and a porous edible particle to obtain a mixture, and
b. Solidifying the mixture obtained in step a.

Mixing is done with the objective to incorporate the oil into the pores of the porous particle.

Mixing the liquid lipid and the porous edible particle can be done at any suitable processing temperature. Preferably, it is done at a temperature of from 60 to 90° C. But it can be done also at room temperature, i.e. from 20 to 25° C.

Mixing the liquid lipid and the porous edible particle can be done by any suitable method for mixing a powder and a liquid, such as mixing with static, passive, in-line or dynamic mixers, such as high speed mixers and high shear mixers. Preferably, use is made of high speed mixing. Such high-speed mixing is for instance mixing at a speed between 100 and 250 rpm.

The lipid to be mixed in step a. of the process should be liquid at processing temperature. When the lipid is not liquid at processing temperature, it can be previously heated to be made liquid. Any other suitable method to obtain a lipid that is liquid at processing temperature can be used.

The lipid is as described hereinbefore. Thus in a preferred embodiment, the lipid comprises oil and fat. Thus in a further preferred embodiment the oil is sunflower oil and the fat is fully hydrogenated sunflower oil.

The porous edible particle is as described hereinbefore. Thus in a preferred embodiment, the edible porous particle is a porous starch granule.

In a further preferred embodiment, the ratio of porous starch, oil and fat is from 1:1:1 to 1:2:3.

Solidifying the mixture can be done by any suitable method known in the art such as for example cooling at room temperature, cooling in an ice bath, refrigerating or blast cooling. The mixture should become solid or semi-solid.

Bakery Product

In a third aspect, the invention relates to a bakery product containing the bakery fat system of the present invention and additional bakery ingredients.

The additional bakery ingredients will be apparent to a person skilled in the art. They may differ in identity and amount, depending on the specific bakery product to be made. This is known by the person skilled in the art. The additional bakery ingredients thus may include for example: flour, raising agents (such as baking powder and/or yeast), water and/or water miscible liquids (such as milk, alcohols, etc.), sweeteners (such as sugar, honey, or artificial sweeteners), dried fruit, chocolate pieces, cacao powder, flavourings (e.g. synthetic or natural flavourings such as vanilla, caramel and/or almond flavourings, fruit extracts, vegetable extracts such as tomato, carrot, onion and/or garlic extracts, spices, herbs, etc.),

salt and/or one or more natural or synthetic colorants. Optionally, vitamins (An, D3, E, K1, C, B1, B2, B5, B6, B12 and PP, folic acid and biotin) and minerals (such as sodium, potassium, calcium, phosphorus, magnesium, chloride, iron, zinc, copper, manganese, fluorine, chromium, molybdenum, selenium and iodine) can also be added.

The flour used in bakery products may be from any source (e.g. corn flour, soy flour or wheat flour). Most preferably, however, it will be wheat flour. Wheat can be any type of wheat varieties which is commonly grown to produce wheat flour.

Use

The bakery fat system of the present invention can be used to make bakery products. Several types of bakery products can be made, such as cookies, biscuits, cakes, muffins, donuts, pastry.

In a preferred embodiment, the bakery fat system is used to make pastry products. In this case the fat system is referred to as pastry fat system.

In a yet further preferred embodiment, the bakery fat system is used to make puff pastry products. In this case, the fat system is referred to as puff pastry fat system.

The use of the bakery fat system of the present application in pastry applications, more particularly in puff pastry applications is possible due to its capacity to be layered and laminated between sheets of dough, without fat leaking out to the dough. This is an important characteristic of fat which can be used for making pastry and more particularly for puff pastry. It results in the typical layered and puffed aspect of pastries and more particular puff pastries.

Methods of Measurement

The oil absorption capacity of a porous particle is measured by centrifuging a given amount of a sample of porous particle in oil dispersion, removing the oil that has not bound to the porous particle, subjecting the remaining oil-loaded porous particle to high centrifugal forces and determining the amount of oil, which remained bound to the starch sample by assessing the weight of the obtained centrifuges starch:

25 g (W₀) of the porous particle is weighed and 25 g of oil is added and thoroughly mixed with a spoon for 2 minutes to give and oil-porous particle mixture. In case of a too high viscosity, an additional amount of oil is added. a 750 ml round bucket centrifuge bottle is filled with about 360 g native potato starch and a folded filter paper (150 mm diameter, Machery-Nagel MN 614) is unfolded and placed on top of the potato starch (in a small hole, to ensure that the filter paper will stay in position during the subsequent centrifugation). The prepared oil-porous particle mixture is then poured onto the filter paper, followed by centrifugation at 3434×g for 10 minutes in a Heraeus Multifuge 3S centrifuge. After completion of the centrifugation, the filter paper with the starch-porous particle sample was withdrawn from the centrifuge bottle, and the starch-porous particle sample remaining on the filter was carefully removed and the weight Wₛ was measured. The oil absorbed by the sample is calculated as Wₛ-W₀ and the oil absorption capacity (%) is expressed as (Wₛ−W₀)/W₀×100% (with a deviation of about 3%).

The density is measured as follows, it is the loose density:

A metal beaker of 100 cm³ is filled with the material under test. It is then weighed and the density is calculated in g/cm³, as the weight of 100 cm³ is known.

The specific surface area is measured as follows:

Surface area is measure with Gemini Analyzer (Micromeritics, Norcross, Ga., USA). The procedure follows that describe in application note 112. That is to say:
1. The sample tube is loaded with the sample
2. The balance tube is loaded with glass beads with an approximate volume the same as the sample.
   a. The volume of the sample in cm3 is determined by v=w/ρ; where w=mass of the sample and ρ=density of the sample (g/cm³).
   b. Determine the number of glass beads to equal the sample volume n=v/0.014 cm³.
3. Outgas the sample
4. Install the sample tube into the analysis port and the balance tube into the balance port.
5. Perform the measurement.
6. Use the measured free space value determine the mass of glass beads to add or subtract (free space×2.515)/3.53=mass of glass beads (g)
7. Remove or add glass beads.
8. Perform the measurement.

The particle size distribution of the porous particle is determined by a sieve analysis using sieves with different openings. The respective sieve fractions on the sieves were weighted and divided by the total weight of the starch sample to give a percentage retained on each sieve.

The hardness is measured as follows:

Hardness of the bakery fat system is measured with the TAXTplus texture analyser (Stable Micro Systems, Godalming, UK). A spindle of 0.5 cm diameter was penetrated into the samples up to 1.5 cm. The samples were measured at 20° C.

The rheology is measured as follows:

Rheological measurements are performed using a modular compact Rheometer model MCR 300 (Anton Paar Physica, Germany).

A configuration with a 25 mm profiled Titanium flat plate (PP 25/P) with a gap of 1 mm to a serrated lower plate is used.

For the temperature sweep measurements, constant amplitude of 0.1 mrad with an angular frequency of 10 rad/s is applied.

The system is cooled at 5° C./minute from 20 to 80° C. Elastic and loss modulus (G′ and G″ respectively) were measured.

The invention is illustrated with the following examples.

### EXAMPLES

Unless otherwise provided, all percentages as described in the examples are weight percentages.

### Example 1

### Preparation of Bakery Fat System

1. Bakery fat system A

Porous corn starch, wherein the starch is in its granular state, having a specific surface area of 0.9m²/g and a density of 0.45 g/cm³ is used for this bakery fat system (hereafter ‘porous corn starch’).

PK4 (Cargill) is a mixture of palm stearin, coconut fat and palm kernel fat.

100 g of porous corn starch and 100 g sunflower oil (Cargill) are mixed and warmed up to 85° C. for 10 minutes under agitation at 250 rpm, with the objective to incorporate the oil into the porous starch. Then the mixture is cooled at 60° C. and mixed in the 100 g of melted fat PK4® at 60° C. stirring at 250 rpm for 5 minutes and then solidified in an ice bath for 2 hours and then tempered at ambient temperature.

The hardness of the bakery fat system A is measured as 1499 kg. The maximum G′ is 452 800 Pa and the maximum G″ is 109 700 Pa. The melting point is 46.2° Ca and the G′ at the melting point is 254.5 Pa.

2. Bakery Fat System B

Starrier R (Cargill) is a roll dried porous starch, wherein the starch is non granular, with a specific surface area of 0.24 m²/g and a density of 0.28 g/cm³.

100 g of Starrier® R and 100 g of sunflower oil (Cargill) are mixed and warmed up to 85° C. for 10 minutes under agitation at 250 rpm, with the objective to incorporate the oil into the porous starch. Then the mixture is cooled at 60° C. and mixed with 100 g of melted fat PK4 at 60° C. It is stirred at 250 rpm for 5 minutes and then solidified in an ice bath for 2 hours and then tempered at ambient temperature.

The hardness is 1.742 kg. The maximum G′ is 1638000 Pa and the maximum G″ is 261400 Pa.

3. Bakery Fat System C

Clear Valley Oil Purpose (CVAP) is an all-purpose shortening from Cargill. It consists of canola oil and hydrogenated cottonseed oil with citric acid as an added preservative. Bakery fat system C is a 50:50 mixture of porous corn starch and CVAP. 500 g porous corn starch and 500 g CVAP are mixed for 3 minutes in a Hobart N-50 on low speed, setting 1.

4. Bakery Fat System D

Bakery fat system D is a 40:60 mixture of Starrier® R and CVAP. 400 g of Starrier R and 600 g of CVAP are mixed for 3 minutes in a Hobart N-50 on low speed, setting 1.

5. Bakery Fat System E

Bakery system E consists of CVAP.

### Example 2

### Porous Starch-Puff Pastry 1

Four sets of puff pastry are prepared:

Puff pastry 1: made with a control bakery fat system (commercially available for puff pastry).

Puff pastry 2: made with bakery fat system C.

Puff pastry 3: made with bakery fat system D.

Puff pastry 4: made with bakery fat system E.

For each puff pastry, the ingredients are as follows:

| Ingredient | % |
|---|---|
| All-Purpose Flour | 39 |
| Salt | 1 |
| CVAP, cold, 2-4° C. | 9 |
| Water, cold, 2-4° C. | 21 |
| Bakery fat system | 30 |

Each bakery fat system was formed into a rectangle, wrapped in plastic wrap and refrigerated at 2-4° C. to harden. Flour and salt are mixed. Small pieces of cold shortening are cut and sifted into the flour-salt mix. A depression is made into the flour-salt mix and all the water is poured into it. The water is slowly incorporated manually into the mix. When a dough is formed, it is kneaded by hand about five turns. It is rolled into a ball and refrigerated overnight at 2-4° C.

The next day, the dough is rolled out into a square large enough to encase the bakery fat system. The four corners of the dough are folded over the bakery fat system and sealed by hand. This is rolled out to a rectangle, taking care that the bakery fat system does not leak out. The dough is then 3-folded and refrigerated for 30 minutes. The roll-out, folding and refrigeration is repeated four times. Folded edges are trimmed off to allow expansion of the layers during bake. Samples are baked at 400° F. for 20 minutes.

Puff pastry with bakery fat system E cannot be made as the fat leaks out of the layers.

### EXAMPLE 3

### Croissants

Four sets of croissants are prepared:

Croissant 1: made with commercial roll-in fat as bakery fat system.

Croissant 2: made with bakery fat system C.

Croissant 3: made with bakery fat system D.

Croissant 4: made with bakery fat system E.

For each set of croissants, the ingredients are as follows:

Pre-Ferment

| Ingredient | % |
|---|---|
| All purpose flour | 62.3 |
| Milk | 37.4 |
| Yeast | 0.3 |
| Total | 100.0 |

Final Dough

| Ingredient | % |
|---|---|
| Flour (Unbleached) | 40.5 |
| Water | 10.8 |
| Milk | 10.8 |
| Sugar | 5.4 |
| Salt | 1.2 |
| Yeast | 1.8 |
| Butter | 1.6 |
| Pre-ferment | 27.8 |
| Total | 100.0 |

Bakery fat system: 27.8% of the dough weight.

Preparation of the pre-ferment:

All the pre-ferment ingredients are mixed together just until ingredients are well incorporated and a smooth dough is obtained. Fermentation is done for 10-12 hrs at 70° F. (21.1° C.).

Preparation of the dough:

All dough ingredients are mixed using a Hobart A200 planetary mixer (Hobart Troy Ohio) with dough hook attachment. Ingredients are incorporated on first speed for 3 minutes, then mixed for 4 minutes on second speed. The resulting dough is smooth, but not fully developed; its temperature is 72° F. The dough is then fermented for 1 hour at ambient temperature (around 69° F.). The dough is punched down and refrigerated to 45° F. (7.2° C.). It is rolled into rectangle and butter is incorporated. A 3-fold and 25-minute chill is performed 3 times. The dough is then rolled to its final thickness of 4.5 mm to 5 mm on a SSO 67 Rondo Sheeter (Seewer AG, Burgdorf, Switzerland). It is cut to shape and proofed for another 1.5 hrs at 76° F. (24.4° C.). It is then baked for 16-18 minutes at 400° F. (204° C.).

The croissants all have a good general appearance.

### Example 4

### Refrigerated Crescent Rolls

Refrigerated crescent rolls are prepackaged semi-finished products for home baking. Two sets of refrigerated crescent rolls are made:

Refrigerated crescent roll 1: with bakery fat system C

Refrigerated crescent roll 1: with bakery fat system D.

For each set of refrigerated crescent rolls, the ingredients are as follows:

| Ingredient, 1st Stage | % |
|---|---|
| Hard Red Spring Wheat | 51.2% |
| Flour | |
| Shortening, Master Chef AP | 6.8% |
| Water | 30.7% |
| Xanthan | 0.2% |
| Datem | 0.3% |
| Turmeric extract, color | 0.028% |

| Ingredient, 2nd Stage | % |
|---|---|
| SAPP 4 (Innophos) | 1.2% |
| SALP (Levin-Lite) | 0.2% |
| Sodium Bicarbonate | 1.0% |
| Salt | 1.3% |
| Sugar, Granulated | 3.0% |
| Dextrose | 4.1% |

Bakery fat system is 27% of the dough weight.

The first stage ingredients are mixed together in a Hobart A200 planetary mixer (Hobart Troy Ohio) at first speed for 2 minutes, and then the second stage ingredients are added and mixed at first speed for 4 minutes The bakery fat system of the present invention can also be characterized by its elastic and loss modulus at its melting point. The elastic modulus is preferably from 200 Pa to 1500 Pa and more preferably from 600 Pa to 1200 Pa. The loss modulus is preferably form 200 Pa to 1500 Pa and more preferably form 600 Pa to 1200 Pa.

The bakery fat system of the present invention can also be characterized by its maximum elastic and loss modulus. The elastic modulus is preferably from 150000 Pa to 3000000 Pa and more preferably from 2000000 Pa to 3000000 Pa. The loss modulus is preferably form 40000 Pa to 400000 Pa and more preferably form 200000 Pa to 300000 Pa.

The shortening is then incorporated and mixed for 4 minutes at first speed and the dough is sheeted into rectangles. It is then perforated (but not separated) into triangles and rolled. The doughs are then packaged in cans and refrigerated, 2-4° C. After several days under refrigerated storage, the doughs are formed and baked at 375° F. for 12 minutes.

Baking with bakery fat systems C and D give acceptable crescent rolls of similar properties to a commercial sample.

### Example 5

### Pie Crust

A blend of 30% Starrier R and 70% CVAP is prepared by mixing both ingredients for 3 minutes at speed 1 in a Hobart N-50. Pie crust is prepared using this as a shortening.

The ingredients are as follows:

| Ingredient | % |
|---|---|
| Pastry flour | 59 |
| Shortening | 25 |
| Water, cold, 2-4° C. | 12 |
| Sugar | 3 |
| Salt | 1 |
| Total | 100 |

The oven is preheated to 350F (177° C.) with convection. The sugar and salt are dissolved in the water, and set aside. Half of the flour and the shortening are blended together at first speed for 15 seconds in a Hobart A200 planetary mixer (Hobart Troy Ohio). The second half of the flour is added, and then the system is blended for 20 seconds at first speed. The bowl is scraped. The sugar and salt solution is added and blended in for 15 seconds at first speed. The bowl is scraped. It is blended for 15 seconds further at first speed, sheeted and cut. The dough is baked for 13 minutes at 350° F.

The baked pie disks have acceptable appearance and properties.

### Example 6

### Comparison Between N-Zorbit and Porous Starch

The maximum level of addition of a porous particle to an oil is the level that can create a structured fat system wherein the lipid is present as a continuous phase. This maximum level is determined for N-Zorbit® (tapioca starch available from National Starch), porous corn starch and Starrier R.

100 g of sunflower oil is held in a beaker at 60° C. This is gently agitated. The porous particle under test is slowly added to the oil. At the point where the system becomes a powder (i.e. the system is no longer a structured fat system wherein the lipid is present as a continuous phase), no more addition of particle is made. The system was then weighed and the weight of added powder determined. Thereby the maximum limit for a bakery fat system could be determined.

The results are as follows:

| | Density | Mass of added | % of particles in |
|---|---|---|---|
| Porous edible particle | g/cm³ | particles/g | system |
| N-Zorbit ® | 0.04 | 30 | 23% |
| Porous corn starch | 0.45 | 200 | 67% |
| Starrier ® R | 0.28 | 210 | 68% |

Without wishing to be bound by theory, it is believed that, since N-Zorbit® is a hollow particle, it entraps the lipid and therefore the lipid cannot form a continuous phase in the system.

Also the oil absorption capacity is measured for N-Zorbit®, porous corn starch and Starrier® R. The method of measurement is as described in a previous part of this description. The oil used is sunflower oil (Vandemoortele, Belgium). The oil absorption capacity is in the range of:

N-Zorbit®: 76%

Porous corn starch: 22%

Starrier® R: 27%

### Example 7

### Biscuits

Biscuits are prepared according to the following recipe: 42.3% wheat flour, 25.6% sugar, 20.7% shortening, 5.8% egg, 4.8% water, 0.5% baking powder and 0.3% salt.

Dough preparation:
1. Cream shortening, sugar, water and salt together for 30 seconds at speed 1 in a Hobart mixer
2. Add eggs and mix for 30 seconds at speed 1
3. Scrape the bowl in order to bring all ingredients on the side of the bowl into the mixture
4. Continue mixing for 4 minutes at speed 2
5. Add half of the baking powder and flour and mix at speed 1 for 30 seconds
6. Add the remaining baking powder and flour and mix for 30 seconds at speed 1
7. Mix for 3 minutes at speed 2 until a homogenous dough is formed

Laminating and dough moulding:
1. Thickness dough sheet 3 mm
2. Diameter cutter 60 mm

Baking: bake the biscuits in an oven with a top and bottom temperature of 190° C.

The following shortenings were compared:
1. 100% CVAP
2. Bakery fat system C
3. Bakery fat system: defatted cocoa powder/CVAP 50:50
4. Bakery fat system: milled Prosante® EXTM-3P spray dried soy protein/CVAP
5. Bakery fat system: maltodextrin/CVAP 50:50

6. Bakery fat system: maltodextrin/CVAP 35:65

The biscuits made using the bakery fat systems according to the present invention are very similar in visual and textural (crispiness, crunchiness) appearance compared to the biscuits made with only CVAP. The biscuit made with cocoa powder is naturally somewhat darker.

1. A bakery fat system comprising from 30 weight/weight % (w/w %) to 75 w/w % of a lipid and from 25 w/w % to 70 w/w % of a porous edible particle, characterized in that said bakery fat system is a structured fat system wherein the lipid is present as a continuous phase.

2. The bakery fat system according to claim 1, characterized in that the lipid comprises oil and fat.

3. The bakery fat system according to claim 1, characterized in that the porous edible particle has an oil absorption capacity of from 15 to 50%.

4. The bakery fat system according to claim 1, characterized in that the porous edible particle is porous starch.

5. The bakery fat system according to claim 1, characterized in that said bakery fat system has a hardness of 0.5 to 2.5 kg at 20° C.

6. The bakery fat system according to claim 4, characterized in that the porous starch has a density of from 0.2 to 0.8 g/cm³ and a specific surface area of from 0.2 to 2 m²/g.

7. The bakery fat system according to claim 1, characterized in that said bakery fat system is a pastry fat system.

8. A process for making the bakery fat system of claim 1, comprising:
a. Mixing a porous edible particle with a liquid lipid to obtain a mixture; and
b. Solidifying the mixture.

9. The process according to claim 8, characterized in that the porous edible particle is porous starch.

10. A bakery product comprising the bakery fat system according to claim 1 and other bakery product ingredients.

11. The product of claim 10, characterized in that the bakery product is a pastry product.

12. The product of claim 11, characterized in that the bakery product is a puff pastry product.

13. Use of the bakery fat system of claim 1 to make a bakery product.

14. The use according to claim 13, characterized in that the bakery product is a pastry.

15. The use according to claim 14, characterized in that the pastry is a puff pastry.
